(19) United States
(12) Patent Application Publication
(10) Pub. No.: US 2026/0318686 A1
(43) Pub. Date: Oct. 15, 2026

(54) Method for Correcting an Attitude Provided by a Dead Reckoning Navigation System by Means of a Relative Positioning System

(71) Applicant: SYSNAV, VERNON (FR)

(72) Inventors: David VISSIERE, PARIS (FR); Mathieu HILLION, VERNON (FR); David LEBEL, VERNON (FR); Maxime LUCAS, COLOMBE (FR)

(21) Appl. No.: 18/877,062

(22) PCT Filed: Jul. 10, 2023
(86) PCT No.: PCT/FR2023/051071

§ 371 Date: Dec. 19, 2024

(30) Foreign Application Priority Data
Jul. 8, 2022 (FR) 2207063

(51) Int. Cl. G01C 21/16; G01C 25/00

(52) U.S. Cl. CPC G01C 21/165; G01C 25/005

(57) ABSTRACT

The invention relates to an attitude correction method (107) comprising estimating (116), by means of a dead reckoning navigation system (22), multiple estimated positions of the dead reckoning navigation system (22) in an arbitrary fixed reference frame at times of determination, obtaining (114) positions, evaluated by a relative positioning system (24), of the dead reckoning navigation system (22) in a predetermined fixed reference frame at the determination times and inferring (124) at least one attitude correction parameter by minimising a cost function comparing the evaluated positions with the estimated positions corrected by means of the or each correction parameter.

### FIELD OF THE INVENTION

The present invention concerns dead reckoning navigation techniques, more particularly techniques for resetting an attitude provided by a dead reckoning navigation system. It finds an advantageous application in the case of movements in an urban or indoor environment, i.e. inside buildings.

### TECHNOLOGICAL BACKGROUND

It is now common to track the position of an object by multi-lateration, by measuring the distances between a receiver attached to the object and at least three sources whose location in the environment is known. This is the case, for example, with the positioning systems of the GNSS (Global Navigation Satellite System, for example GPS) type or benefiting from the infrastructure of a wireless communication network (for example Wi-Fi network, GSM network, etc.). However, these methods are very limited because they do not ensure availability and accuracy of the information, both of which being affected by possible masking between the sources and the receiver. Their use in an urban or indoor environment therefore requires the deployment of an expensive infrastructure with numerous sources distributed throughout the environment. They are also dependent on external technologies such as satellites for GNSS, which may be unavailable or even deliberately jammed.

Alternatively, methods called dead reckoning navigation methods are also known to track the relative position of an object in any environment thanks to a motion sensor measuring the motion of the object. By relative position, it is meant the position of the object in space with respect to a given point and coordinate system at initialization. In addition to the position, these methods also make it possible to obtain the orientation (also called “attitude”) of the object with respect to the same initial coordinate system, which is given, in dimension 3, by the Euler angles (roll (p, pitch 6, yaw LV) and, in dimension 2, by the heading ψ. These methods are preferred in the case of movement in an environment where the position tracking by multi-lateration is difficult, for example the urban or indoor environments.

There are different types of dead reckoning navigation. The most common is the navigation called “simple” inertial navigation, as implemented in heavy applications such as the navigation of fighter aircrafts or airliners, submarines, ships, etc. It is based on inertial units generally comprising a minimum of three accelerometers and three gyrometers disposed in triaxis. Typically, the gyrometers “maintain” a coordinate system, in which a double temporal integration of the accelerometer measurements makes it possible to estimate the motion. It is well known that in order to use this “simple” inertial navigation method, it is necessary to use very high-accuracy sensors. Indeed, the double temporal integration of an acceleration measurement means that a constant acceleration error creates a position error that increases proportionally to the square of time.

Another known dead reckoning navigation technique is the technique in which the velocity vector information in the coordinate system of the object is provided by an outer source (for example an odometer for a car, a log for a boat or a Pitot tube for an airplane). It is then sufficient to apply a simple integration to this velocity vector information and to combine it with orientation and in particular heading information on the object to know its trajectory. For the same measurement inaccuracy of the sensors, the time drift is then less sensitive.

Most often, the initial attitude is known, for example by initial “alignment” of an inertial device or by supply by sensors other than inertial sensors (for example magnetic sensors). However, the measurement inaccuracy of the inertial sensors induces a time drift of the measured attitude, which makes the knowledge of the initial attitude obsolete after a more or less long time depending on the accuracy of the sensors used and leads to inaccuracies on the location of the object. For example, a 1% error in the heading measurement leads, after a 100 m movement, to an inaccuracy of 1 m in the location of the object.

To address this, it is known to regularly reset the measurements of a dead reckoning navigation system by means of another positioning system, so as to best maintain the orientation information of the object, particularly the heading information. For example, it is known from WO 2019/020961 to reset the orientation information by using a magnetic heading measurement obtained by a magnetometer carried by the object.

However, this solution is not entirely satisfactory. Indeed, the magnetometers suffer from their own inaccuracies and drifts which mean that their measurements are sometimes insufficiently reliable to be used as a basis for resetting. Furthermore, this solution requires integrating magnetometers into the object whose position is to be tracked, which increases its cost.

### DISCLOSURE OF THE INVENTION

One objective of the invention is to propose a simple and economical solution for resetting an attitude provided by a dead reckoning navigation system. Another objective is to allow such resetting with great accuracy over a short distance. Another objective is to allow, in a simple and economical manner, accurate tracking of people moving inside a building.

To this end, the invention relates, according to a first aspect, to an attitude resetting method for resetting an attitude provided by a dead reckoning navigation system, the resetting method comprising the following steps:
estimating, by the dead reckoning navigation system, for each of a plurality of determination instants comprised in a movement interval during which the dead reckoning navigation system moves along a movement trajectory, an estimated position of the dead reckoning navigation system in an arbitrary fixed coordinate system at said determination instant,
obtaining, for each determination instant, an evaluated position of the dead reckoning navigation system at said determination instant in a predetermined fixed coordinate system, said evaluated position having been evaluated by a relative positioning system, and
deducing at least one attitude resetting parameter by minimizing a cost function comparing the evaluated positions with the estimated positions corrected by means of the or each resetting parameter.

According to particular embodiments of the invention, the attitude resetting method also has one or more of the following characteristics, taken separately or in any technically possible combination(s):
the dead reckoning navigation system is worn by a pedestrian, the dead reckoning navigation system being preferably attached to a foot or ankle of the pedestrian;
the dead reckoning navigation system includes a motion sensor for measuring a motion of the dead reckoning navigation system and a processing unit for deducing from the measured motion an attitude and a position of the dead reckoning navigation system;
the relative positioning system is selected from: a multi-angulation system, a multi-lateration system, a map matching system and a visual positioning system, the relative positioning system preferably comprising an ultra wide band telemetry device;
the arbitrary fixed coordinate system and the predetermined fixed coordinate system share a common axis, an attitude resetting parameter being constituted by a parameter, preferably an angle, of modification of orientation by rotation about said common axis;
the common axis is a vertical axis;
the cost function is representative of an average geometric deviation between the evaluated positions and the estimated positions after application to the evaluated or estimated positions of a geometric transformation comprising a rotation and, preferably, a translation;
the rotation is about an axis of rotation and the translation is in a direction orthogonal to said axis of rotation;
the step of deducing the resetting parameter comprises the calculation of a candidate value for the resetting parameter, the evaluation of an accuracy value of said candidate value, the comparison of said accuracy value with a previous accuracy value associated with a previous resetting parameter, and the determination of the resetting parameter as a function of the result of the comparison, the resetting parameter depending on the candidate value and on the previous resetting parameter.
the accuracy value is a function of uncertainties on the estimated positions and the evaluated positions and/or of an average geometric deviation between the evaluated positions and the estimated positions after application of the candidate value of the resetting parameter.
the deduction of the resetting parameter comprises the following sub-steps:
   a) calculating a first candidate value for the resetting parameter by minimizing a cost function comparing the positions evaluated for N determination instants with the positions estimated for said N determination instants corrected by means of the resetting parameter,
   b) calculating a first accuracy value associated with said first candidate value,
   c) calculating a second candidate value for the resetting parameter by minimizing a cost function comparing the positions evaluated for N−1 determination instants, corresponding to said N determination instants minus the oldest determination instant, with the estimated positions for said N−1 determination instants corrected by means of the or each resetting parameter,
   d) calculating a second accuracy value associated with said second candidate value,
   e) comparing the first and second accuracy values, and
   f) selecting the first candidate value when the first accuracy value reflects the best accuracy;
when the accuracy value reflecting the best accuracy is constituted by the second accuracy value, the deduction of the resetting parameter comprises the following additional sub-steps:
   deleting the evaluated position and the estimated position for the oldest determination instant, and
   repeating the sub-steps a) to e) with a number N reduced by 1; and
the dead reckoning navigation system has an accuracy in traveled distance of the order of a few percent, for example between 1 and 3%, and of a few tens of degrees per hour, for example between 30 and 80 degrees per hour, in heading drift, and the relative positioning system has an accuracy of a few tens of centimeters, for example between 20 cm and 1 m, in position.

The invention also relates, according to a second aspect, to a method for locating an object in a predefined space, the method comprising the following steps:
starting the dead reckoning navigation system,
resetting the attitude of the dead reckoning navigation system using a relative positioning system comprising an infrastructure installed at a point of access to the predefined space, so as to obtain an attitude resetting parameter, said attitude resetting implementing an attitude resetting method according to any one of the preceding claims,
resetting the position of the dead reckoning navigation system using a relative positioning system comprising an infrastructure installed at said point of access to the predefined space, so as to obtain a position resetting parameter, and
calculating, by the dead reckoning navigation system, by means of the attitude resetting parameter and the position resetting parameter, a calculated position of the dead reckoning navigation system in the predetermined coordinate system.

According to one particular embodiment of the invention, the location method also has the following characteristic:
the infrastructure is carried on board a vehicle itself equipped with a location and orientation system making it possible to calculate the position of the infrastructure in the predetermined coordinate system.

The invention also relates, according to a third aspect, to a dead reckoning navigation system including a motion sensor for measuring a motion of the dead reckoning navigation system and a processing unit for deducing from the measured motion an attitude and a position of the dead reckoning navigation system in a fixed coordinate system, the processing unit being configured to implement an attitude resetting method according to the first aspect to reset said attitude.

According to a fourth aspect, the invention relates to a computer program product comprising code instructions for the execution of an attitude resetting method according to the first aspect when said program is executed by a processor.

Finally, according to a fifth aspect, the invention relates to a storage means readable by computer equipment on which a computer program product comprising code instructions for the execution of an attitude resetting method according to the first aspect is recorded.

### BRIEF DESCRIPTION OF THE FIGURES

Other characteristics and advantages of the invention will appear upon reading the following description, given only by way of example and with reference to the appended drawings, in which:

FIG. 1 is a top view of a system for locating an object in a predefined space according to one exemplary embodiment of the invention,

FIG. 2 is a perspective view of a detail of the location system of FIG. 1,

FIG. 3 is a diagram of a location box of the location system of FIG. 1,

FIG. 4 is a diagram illustrating one example of a method for locating an object in a predefined space implemented by the system of FIG. 1,

FIG. 5 is a diagram illustrating a heading resetting step of the method of FIG. 4, and

FIG. 6 is a diagram illustrating a sub-step of deducing a heading resetting parameter of the heading resetting step of FIG. 5.

### DETAILED DESCRIPTION OF ONE EXEMPLARY EMBODIMENT

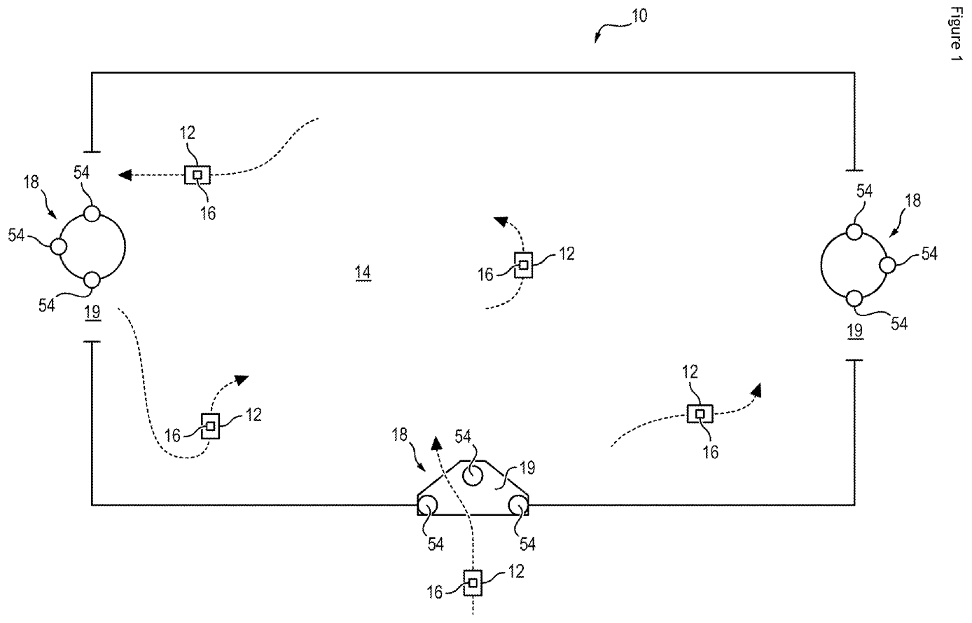

The location system 10 represented in FIG. 1 is intended for locating objects of interest 12 within a predefined space 14. For this purpose, the location system 10 comprises a plurality of location boxes 16 each attached to a respective object of interest 12. Here, the location system 10 also comprises a location infrastructure 18 arranged at least at one point of access 19 to the predefined space 14.

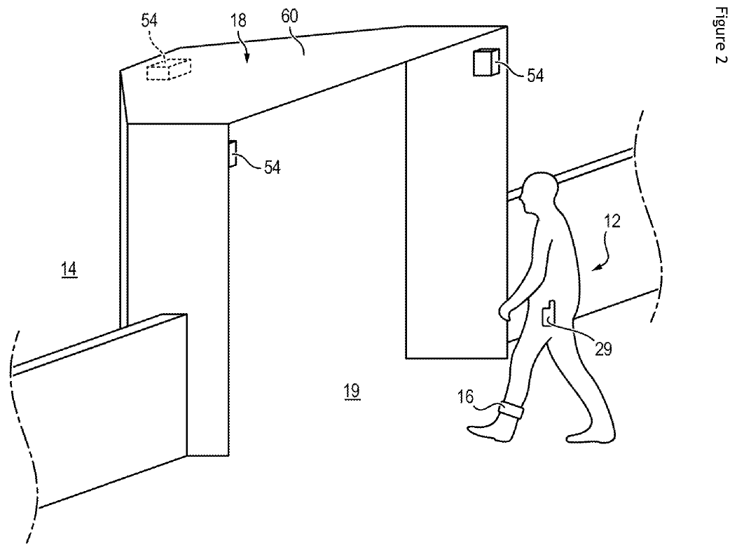

With reference to FIG. 2, each object of interest 12 here consists of a pedestrian. The invention is particularly advantageous in such a use because it allows a much reduced bulk of the boxes 16, which can thus be easily worn ergonomically by pedestrians. As a variant (not represented), the objects of interest 12 consist of any mobile object whose position knowledge is desired, for example a wheeled vehicle, a drone, etc.

The predefined space 14 is typically constituted by a building interior. For example, if it is an industrial site, the pedestrians 12 are then typically technicians working on said industrial site. As a variant, if the predefined space 14 is an intervention site for example a building on fire or a hostage-taking place, the pedestrians 12 are then firemen or infantrymen intervening on said site.

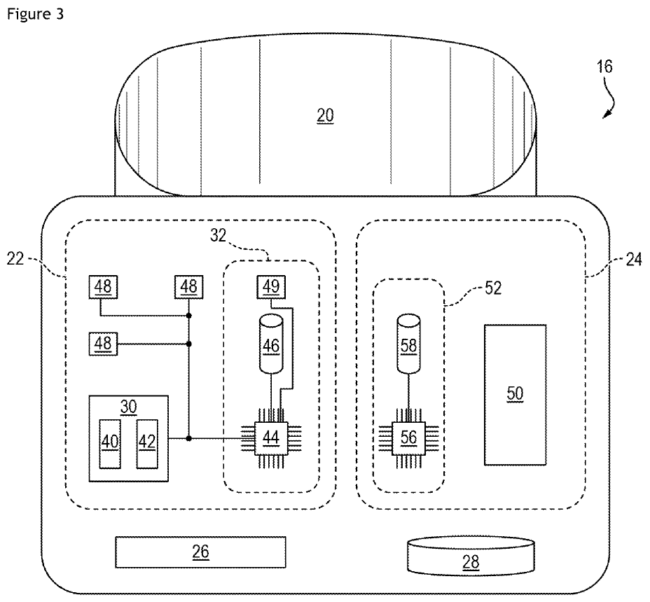

Each location box 16 is typically attached to a limb, here a leg, preferably a foot or an ankle, of the pedestrian 12. For this purpose, each location box 16 comprises, as visible in FIG. 3, an attachment member 20 here constituted by a bracelet for example with a hook-and-loop strip which encircles the limb and allows the secured connection. As a variant (not represented), the attachment member 20 is constituted by any element allowing a connection secured to the location box 16 with the object of interest 12.

Still with reference to FIG. 3, the location box 12 comprises a dead reckoning navigation system 22. It also comprises a relative positioning system 24. In the example represented, it also comprises a communication system 26, typically a wireless communication system, for the communication of the location box 12 with an outer device such as a mobile terminal 29 (FIG. 2), for example a multifunction mobile, or even a remote server (not represented). Optionally, it includes a storage module 28.

The dead reckoning navigation system 22 comprises a motion sensor 30 for measuring a motion of the dead reckoning navigation system 22 and a processing unit 32 for deducing from the measured motion an attitude and a position of the dead reckoning navigation system 22 in a predetermined fixed coordinate system, for example the East-North-Up (ENU) coordinate system. By “fixed coordinate system”, it is meant here and hereinafter that the coordinate system is stationary in the terrestrial reference frame.

In the example described here, the dead reckoning navigation system 22 is configured to work in a two-dimensional coordinate system and to provide only a heading and two position coordinates of the dead reckoning navigation system 22 in a horizontal plane of the predetermined coordinate system. As a variant (not represented), the dead reckoning navigation system 22 is configured to work in a three-dimensional coordinate system and therefore to provide a roll angle, a pitch angle and a yaw angle of the dead reckoning navigation system 22, as well as its three position coordinates in the predetermined coordinate system. Those skilled in the art will be easily able to transpose to the three-dimensional case the example given here of the two-dimensional case.

The motion sensor 30 comprises a gyrometer 40 for measuring an angular velocity of the dead reckoning navigation system 22 according to a system with three orthogonal axes defining a mobile coordinate system secured to the box 16, i.e. measuring the three components of an angular velocity vector in said mobile coordinate system. It is thus understood that the gyrometer 40 can in fact designate a set of three gyrometers associated with one of the three axes, particularly in tri-axis (i.e. each able to measure one of the three components of the angular velocity vector).

The motion sensor 30 also comprises a member 42 for acquiring a linear velocity of the dead reckoning navigation system 22, i.e. of the movement. This acquisition member 42 makes it possible to obtain the linear velocity directly or indirectly, and thus be of various types.

For example, the acquisition member 42 can consist of one or more accelerometers (not represented). These accelerometers are advantageously disposed in tri-axis, typically according to the same system with three orthogonal axes as the gyrometer 40. They are sensitive to external forces other than gravitational forces applied to the sensor 30, and make it possible to measure a specific acceleration. The linear velocity is then obtained by temporal integration of this acceleration.

As a variant, when the object 12 is a wheeled vehicle, the acquisition member 42 consists of at least two odometers each for a wheel of the vehicle, for example the two rear wheels. By odometer it is meant equipment capable of measuring the speed of a wheel by counting the revolutions (“rev counter”). Generally, the odometers have a part fixed to the wheel (for example a magnet), and detect each passage of this fixed part (called “top”) so as to count the number of revolutions per unit of time, which is the rotational frequency. Other techniques are known, for example the optical detection of a print on the wheel, or the magnetometer of patent FR 2 939 514 which detects the rotation of a metal object such as a wheel. Here the “speed” of a wheel is a scalar, i.e. the norm of the speed of the wheel in the terrestrial reference frame (assuming there is no skidding). If the spoke of the wheel is known, measuring the rotational frequency makes it possible to estimate this speed norm.

Optionally, the motion sensor 30 also comprises a stride detector (not represented) to detect when the foot of the pedestrian 12 is on the ground, as described for example in document WO 2017/060660.

In the example represented, the processing unit 32 is constituted by a programmable machine, such as a DSP (Digital Signal Processor) or a microcontroller. It comprises a processor or CPU (Central Processing Unit) 44 and a memory 46 of the RAM (Random Access Memory) and/or ROM (Read Only Memory) type. The processor 44 is configured to execute instructions loaded into the memory 46. When the dead reckoning navigation system 22 is powered on, the processor 44 is capable of reading instructions from the memory 46 and executing them. These instructions form a computer program causing the calculation, by the processor 44, of the heading and position of the dead reckoning navigation system 22 in the predetermined fixed coordinate system, for example by the implementation of the method described in WO 2017/060660 or FR 2 939 514.

As a variant (not represented), the processing unit 32 is constituted by a dedicated machine or component, such as an FPGA (Field-Programmable Gate Array) or an ASIC (Application-Specific Integrated Circuit).

The processing unit 32 also comprises a buffer memory 49 for the temporary storage of information necessary for the calculation of the position of the heading and the position of the dead reckoning navigation system 22 in the predetermined fixed coordinate system.

Optionally, the dead reckoning navigation system 22 also comprises a network of magnetometers 48 linked to the box 16, i.e. they each have a motion substantially identical to that of the box 16 in the terrestrial reference frame, and spatially spaced from each other. Each magnetometer 48 is a tri-axis magnetometer capable of measuring a magnetic field along three axes. For this purpose, each magnetometer 48 is typically constituted by three single-axis magnetometers (not represented) oriented along axes substantially perpendicular to each other. These axes are preferably the same as those of the system with three orthogonal axes of the gyrometer 40.

The network of magnetometers 48 is capable, due to its particular geometry, of authorizing the determination, at each measurement instant of the magnetometers 48, of a spatial gradient of the measured magnetic field, particularly of the coefficients of this gradient along each of the axes of the moving coordinate system linked to the box 16. Each coefficient of said gradient is for example determined by a method using the vector measurements of the magnetic field made by the magnetometers 48, associated with optimization methods of the least square or median filter type or associated with the intrinsic properties of the magnetic field described by Maxwell's equations. However, any other conventional method adapted to calculate the coefficients of the spatial gradient of the magnetic field is suitable.

The processing unit 32 is then typically configured to adjust the determination of the velocity of the dead reckoning navigation system 22 by implementing the method described in EP 2 541 199.

The dead reckoning navigation system 22 typically has an accuracy of the order of a few percent, for example between 1 and 3%, in distance traveled and of a few tens of degrees per hour, for example between 30 and 80 degrees per hour, in heading drift.

The relative positioning system 24 is capable of identifying a relative position of a point secured to the dead reckoning navigation system 22 relative to a reference system with a known position in the predetermined fixed coordinate system, and of deducing therefrom the position of the dead reckoning navigation system 22 in the predetermined fixed coordinate system. For this purpose, the relative positioning system 24 comprises a sensor 50 capable of measuring a parameter making it possible to locate the secured point with respect to the reference system, and a processing unit 52 for deducing from this parameter a position of the dead reckoning navigation system 22 in the predetermined fixed coordinate system.

Preferably, the relative positioning system 24 is constituted by a multi-lateration system, particularly by a proximity multi-lateration system. The infrastructure 18 then comprises, at the or each access point 19, at least three beacons 54 (FIG. 2) (or “anchors”) each having a known position in the predetermined fixed coordinate system and with which the relative positioning system 24 is configured to communicate. For this purpose, the sensor 50 is typically constituted by a wireless communication system capable of communicating with the beacons 54 and of deducing the distance with each beacon 54, for example by measuring the two-way ranging (TWR) distance.

Preferably, the sensor 50 is constituted by an ultra wide band telemetry device capable of communicating with the beacons 54 and measuring its distance from the beacons 54 via the ultra wide band (UWB) protocol, which allows accuracy in the measurement of the position of the order of ten centimeters, typically comprised between 20 cm and 1 m. As known to those skilled in the art, the ultra wide band protocol is a radio communication protocol based on the transmission of very short pulses (of the order of a nanosecond) over a wide frequency spectrum. The communications thus benefit from a wide bandwidth (500 to 1,350 MHz) in the range 0.5 to 9.5 GHz (central frequency) depending on the channel used. As a variant, the sensor 50 is capable of communicating with the beacons 54 via the Bluetooth protocol or the Wi-Fi protocol.

As a variant, the multi-lateration system is constituted by a GNSS system.

The processing unit 52 is then configured to deduce from the distance measurements and the known positions of the beacons 54 the relative position of the sensor 50 in the predetermined fixed coordinate system, typically by multi-lateration or by optimization, and to deduce from this position, as well as from the position of the sensor 50 with respect to the dead reckoning navigation system 22, the position of the dead reckoning navigation system 22 in the predetermined fixed coordinate system.

According to another embodiment (not represented), the relative positioning system 24 is constituted by a multi-angulation system, the sensor 50 then being capable of measuring at least one angle between the observation directions of two beacons each having a known position in the predetermined fixed coordinate system. The processing unit 52 is then configured to deduce from the angle measurement(s) and from the known position of the beacons 54 the position of the sensor 50 in the predetermined fixed coordinate system, typically by multi-angulation, and to deduce from this position, and from the position of the sensor 50 with respect to the dead reckoning navigation system 22, the position of the dead reckoning navigation system 22 in the predetermined fixed coordinate system.

According to yet another embodiment (not represented), the relative positioning system 24 is constituted by a map matching system. The sensor 50 is then capable of measuring a parameter of the environment, for example the relief or the magnetic field, and the processing unit 52 is capable of matching this measurement with a map of said parameter it stores in memory, so as to deduce therefrom the position of the sensor 50 in the predetermined fixed coordinate system.

According to a fourth embodiment (not represented), the relative positioning system 24 is constituted by a visual positioning system. The sensor 50 is then constituted by an imager associated with an image processing system. The imager is configured to acquire images of the environment and the processing system to detect in each image a remarkable point, for example a sight, whose position is known in the predetermined fixed coordinate system. The processing unit 52 is then configured to deduce therefrom a relative position of the sensor with respect to the remarkable point, and to deduce from this relative position, as well as from the known position of the remarkable point and the position of the sensor 50 with respect to the dead reckoning navigation system 22, the position of the dead reckoning navigation system 22 in the predetermined fixed coordinate system.

As a variant (not represented), the imager is fixed (it belongs to the infrastructure 18) and it is the remarkable point (typically the sight) which is carried by the box 16. As a further variant, a motion capture configuration can be provided in which several targets are carried by the box 16 and detected by a fixed imager.

In the example represented, the processing unit 52 is constituted by a programmable machine, such as a DSP (Digital Signal Processor) or a microcontroller. It comprises a processor or CPU (Central Processing Unit) 56 and a memory 58 of the RAM (Random Access Memory) and/or ROM (Read Only Memory) type. The processor 56 is configured to execute instructions loaded into the memory 58. When the relative positioning system 24 is powered on, the processor 56 is capable of reading instructions from the memory 58 and executing them. These instructions form a computer program causing the calculation, by the processor 56, of the position of the dead reckoning navigation system 22 in the predetermined fixed coordinate system from the parameter measured by the sensor 50.

As a variant (not represented), the processing unit 52 is constituted by a machine or a dedicated component, such as an FPGA (Field-Programmable Gate Array) or an ASIC (Application-Specific Integrated Circuit).

In the example represented, the processing unit 52 of the relative positioning system 24 is distinct from that 32 of the dead reckoning navigation system 22. As a variant (not represented), these processing units 32, 52 are merged.

The communication system 26 is configured to implement short-range wireless communication, for example Bluetooth or Wi-Fi (particularly in one embodiment with a mobile terminal 29) and/or to connect to a mobile network (typically UMTS/LTE/5G) for long-distance communication. As a variant (not represented), the communication system 26 is for example a wired connector technology (typically USB) to transfer the data from the storage module 28 to another storage module, typically the mobile terminal 29.

For example, the communication system 26 is configured to send the position calculated by the dead reckoning navigation system 22 to the mobile terminal 29 for display of the position by the mobile terminal 29 in an interface of navigation software.

In the examples described above, the processing units 32, 52 of the dead reckoning navigation system 22 and of the relative positioning system 24 are integrated into the box 16. As a variant (not represented), at least part of these processing units 32, 52 is moved, for example in the mobile terminal 29, in the infrastructure 18 and/or in a remote server (not represented). In other words, at least part of the steps of calculating the position of the dead reckoning navigation system 22 by the dead reckoning navigation system 22 or by the relative positioning system 24 is performed by the mobile terminal 29, the infrastructure 18 and/or a remote server. The communication system 26 is then configured to send to the mobile terminal 29, to the infrastructure 18 and/or to the remote server the data from the motion sensor 30 and/or from the sensor 50. Advantageously, the communication system 26 is also configured to receive from the mobile terminal 29, from the infrastructure 18 and/or from the remote server the position of the dead reckoning navigation system 22 calculated by the dead reckoning navigation system 22 or by the relative positioning system 24.

Returning to FIGS. 1 and 2, the infrastructure 18 comprises, as described above, a plurality of beacons 54 disposed at the points of access 19 to the predefined space 14. These beacons 54 are typically grouped within portals arranged at the access points 19, such as the portal 60 represented in FIG. 2. Each portal 60 includes a minimum of three beacons 54 so as to allow the positioning of the pedestrians 12 crossing the access point 19 by multi-lateration.

The infrastructure 18 is for example a permanent fixed infrastructure. This is in particular the case when the predefined space 14 is an industrial site and the location system 10 is intended to track the movement of the technicians on said site. As a variant, the architecture 18 is a temporary fixed infrastructure. This is for example the case when the predefined space 14 is an intervention site, in particular in the event of a fire: the infrastructure 18 is then brought and installed at one of the access points of the intervention site before the arrival of the firemen. As a variant again, the infrastructure 18 is a mobile infrastructure. It is typically carried on board a vehicle (not represented) used for the transport of pedestrians 12 whose movement up to the predefined space 14 is to be tracked. This vehicle is then itself equipped with a location and orientation system making it possible to calculate the position of the infrastructure 18 in the predetermined coordinate system. This is the case, for example, when the predefined space 14 is an intervention site, in particular in the event of a hostage-taking.

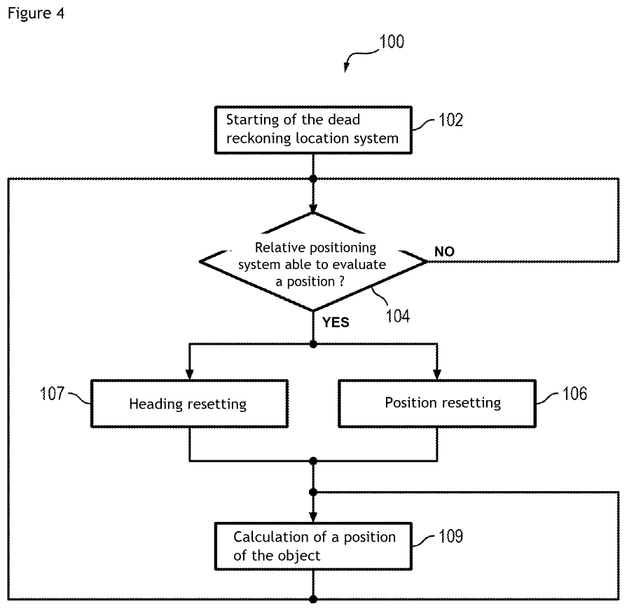

A method 100 implemented by the location system 10, more particularly by the processing units 32, 52, will now be described, with reference to FIGS. 4 to 6.

As visible in FIG. 4, the method 100 begins with a first step 102 of starting the dead reckoning location system 22. This first step 102 is typically implemented while the pedestrian 12 wearing the box 16 is still outside the predefined space 14. Typically, step 102 is triggered by the pedestrian 12 pressing a button (not represented) on the box 16. The relative positioning system 24 typically starts concomitantly with step 102.

After it starts, the dead reckoning location system 22 provides a position

$$v ( t ) = ( \begin{matrix}{v}_{1} ( t ) \\ {v}_{2} ( t )\end{matrix} )$$

of the pedestrian 12 in an arbitrary fixed coordinate system. This position v(t) is affected by a random error. For simplification, this random error is here assimilated to a centered Gaussian variable of variance

$${Γ}_{v} = ( \begin{matrix}Var ( {v}_{1} ) & Covar ( {v}_{1} , {v}_{2} ) \\ Covar ( {v}_{2} , {v}_{1} ) & Var ( {v}_{2} )\end{matrix} ) .$$

For further simplification, it is subsequently assumed that there is no spatial correlation between the directions of the plane, i.e. that the terms Covar(v₁,v₂) and Covar(v₂,v₁) are zero. For the sake of simplicity, it is considered in the following that the terms Var(v₁) and Var(v₂) are equal, so that the variance Γᵥ can be written

$${σ}_{v}^{2} ( t ) \times {I}_{2} ,$$

where σᵥ(t) reflects an uncertainty on the position v(t) and I₂ is the identity matrix of dimension 2. If this uncertainty σᵥ(t) is a priori variable over time, the amplitude of this variation is generally quite low. A constant uncertainty σᵥ is therefore considered here and in the following.

The dead reckoning location system 22 also provides a heading ψ(t) of the pedestrian 12 in said arbitrary fixed coordinate system. This arbitrary fixed coordinate system is a two-dimensional horizontal coordinate system which typically consists of a rotation of the predetermined fixed coordinate system by an angle θ about the vertical axis and a translation of a horizontal vector A. The arbitrary fixed coordinate system thus shares a common axis with the predetermined fixed coordinate system, constituted by the vertical axis. It is chosen arbitrarily by the dead reckoning location system 22 according to its orientation at start-up.

The relative positioning system 24 provides a horizontal position

$$u ( t ) = ( \begin{matrix}{u}_{1} ( t ) \\ {u}_{2} ( t )\end{matrix} )$$

of the pedestrian 12 in the predetermined fixed coordinate system. This position u(t) is affected by a random error. For simplification, this random error is here assimilated to a centered Gaussian variable of variance

$${Γ}_{u} = ( \begin{matrix}Var ( {u}_{1} ) & Covar ( {u}_{1} , {u}_{2} ) \\ Covar ( {u}_{2} , {u}_{1} ) & Var ( {u}_{2} )\end{matrix} ) .$$

For further simplification, it is assumed in the following that there is no spatial correlation between the directions of the plane, i.e. that the terms Covar(u₁,u₂) and Covar(u₂,u₁) are zero. For further simplification, it is considered in the following that the terms Var(u₁) and Var(u₂) are equal, so that the variance Γᵤ can be written

$${σ}_{u}^{2} ( t ) \times {I}_{2} ,$$

where σᵤ(t) reflects an uncertainty on the position u(t) and I₂ is the identity matrix of dimension 2. If this uncertainty σᵤ(t) is a priori variable over time, the amplitude of this variation is generally quite low. A constant uncertainty σᵤ is therefore considered here and in the following.

Step 102 is followed by a step 104 of determining the possibility, for the relative positioning system 24, to evaluate the position of the dead reckoning navigation system 22 in the predetermined fixed coordinate system. If the determination is positive, i.e. typically if the box 16 is within range of the beacons 54 of the infrastructure 18, step 104 is followed by a step 106 of resetting the dead reckoning navigation system 22 in position and a step 107 of resetting the dead reckoning navigation system 22 in heading. If the determination is negative, i.e. typically if the box 16 is out of range of the beacons 54 of the infrastructure 18, step 104 is repeated after a time delay.

During the position resetting step 106, the dead reckoning navigation system 22 estimates the position v(t₀) of the pedestrian 12 in the arbitrary fixed coordinate system at an instant to while the relative positioning system 24 evaluates the position of the pedestrian u(t₀) in the predetermined fixed coordinate system at said instant t₀ and communicates this evaluated position u(t₀) to the dead reckoning navigation system 22. The dead reckoning navigation system 22 then determines a position resetting parameter δ constituted by the difference between the evaluated u(t₀) and estimated v(t₀) positions: Δ=v(t₀)−u(t₀). The dead reckoning navigation system 22 then adjusts the estimated position by applying said position resetting parameter Δ:\hat{v}(t)=v(t)−Δ.

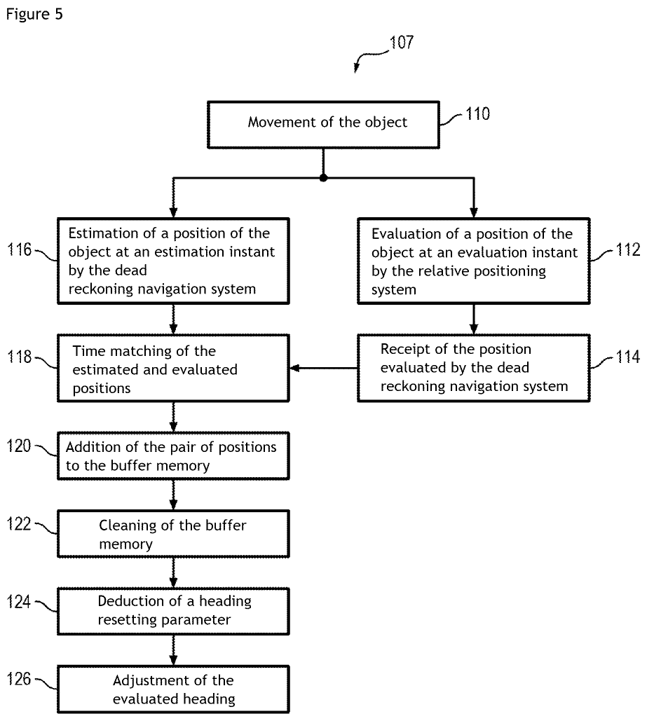

With reference to FIG. 5, the heading resetting 107 begins with the movement 110 of the pedestrian 12 following a movement trajectory during a movement interval while the box 16 is within range of the beacons 54 of the infrastructure 18.

During this movement 110, the heading resetting 107 comprises, for a plurality of evaluation instants iₖ comprised in the movement interval, an evaluation 112 of the position u(iₖ) of the pedestrian 12 by the relative positioning system 24 in the predetermined fixed coordinate system at said evaluation instant iₖ. This evaluation 112 is followed by the receipt 114 of this evaluated position u(iₖ) by the dead reckoning navigation system 22.

In parallel, the heading resetting 107 also comprises, for a plurality of estimation instants τₖ comprised in the movement interval, an estimation 116 of the position v(τₖ) of the pedestrian 12 by the dead reckoning navigation system 22 in the arbitrary fixed coordinate system at said estimation instant τₖ.

The receiving 114 and estimation 116 steps are followed by a step 118 of matching the positions evaluated u(iₖ) and estimated v(τₖ) by the dead reckoning navigation system 22. Indeed, the resetting step 107 is based on the use of evaluated positions synchronous with estimated positions. However, these two types of positions coming from different origins, the evaluation instants iₖ generally differ from the estimation instants τₖ. A matching is therefore necessary between the evaluated u(iₖ) and estimated v(τₖ) positions. This matching aims to associate and synchronize the evaluated u(iₖ) and estimated v(τₖ) positions, in order to be able to have, for each of a plurality of determination instants tₖ, a pair of positions evaluated u(tₖ) and estimated v(tₖ) at said determination instant tₖ. This matching therefore consists in deducing from the set {u(iₖ)}ₖ of the positions evaluated u(iₖ) at the evaluation instants iₖ and from the set {v(τₖ)}ₖ of the positions estimated v(τₖ) at the estimation instants τₖ:
a set {u(tₖ)}ₖ of positions evaluated u(tₖ) at the determination instants tₖ, and
a set {v(tₖ)}ₖ of positions estimated v(tₖ) at the determination instants tₖ,

For this purpose, the matching comprises for example the interpolation of at least one set or subset among:
the set {u(iₖ)}ₖ of the positions evaluated u(iₖ) at the evaluation instants iₖ, and
the set {v(τₖ)}k of the positions estimated v(τₖ) at the estimation instants τₖ.

This interpolation preferably uses temporal splines. Preferably, the splines used for the interpolation are differentiable at least twice. The spline representation makes it possible in particular to force the continuity of the trajectory. The spline representation also makes it possible to optimize the various parameters involved, particularly the temporal synchronization parameters, using a method based on the gradient of a criterion to be minimized. As a variant, the interpolation uses another approach, such as for example a discrete representation of the trajectory traveled by the pedestrian 12.

Preferably, only the set of estimated positions {v(τₖ)}k is interpolated, the determination instants tₖ being chosen to be equal to the evaluation instants iₖ:tₖ=iₖ. The set {u(tₖ)}ₖ of positions evaluated u(tₖ) at the determination instants tₖ is therefore merged with the set {u(iₖ)}ₖ of positions evaluated u(iₖ) at the evaluation instants iₖ. The receipt 114 by the dead reckoning navigation system 22 of a position evaluated u(iₖ) at an evaluation instant iₖ thus constitutes a step of obtaining, by the dead reckoning navigation system 22, an evaluated position u(tₖ) of the pedestrian 12 at a determination instant tₖ.

As a variant, only the set of evaluated positions {u(tₖ)}ₖ is interpolated, the determination instants tₖ being chosen to be equal to the estimation instants τₖ:tₖ=τₖ. The matching 118 thus constitutes a step of obtaining, by the dead reckoning navigation system 22, an evaluated position u(tₖ) of the pedestrian 12 at a determination instant tₖ.

It should be noted that in the case where the evaluation instants iₖ correspond to the evaluation instants τₖ, the matching 118 is limited to associating the evaluated u(iₖ) and estimated v(τₖ) positions with the same instants iₖ, τₖ, which then become determination instants tₖ.

The matching 118 is followed by the addition 120 of the pair of positions u(tₖ), v(tₖ) thus matched in the buffer memory 49 then by the cleaning 122 of the buffer memory 49. This cleaning 122 consists of the deletion from the buffer memory 49 of pairs of positions u(tₖ), v(tₖ) associated with determination instants tₖ which are no longer in the movement interval, the movement interval being understood here as a sliding time window, of predetermined duration, ending on the date of the most recent evaluation iₖ or estimation τₖ instant.

These steps 120, 122 are followed by a step 124 of deducing a heading resetting parameter θ. This heading resetting parameter θ is here constituted by a parameter, particularly an angle, of modification of orientation by rotation about an axis of the predetermined coordinate system, here the vertical axis. Optionally, the heading resetting 107 also comprises, in parallel with step 124, other steps (not represented) of deducing other heading resetting parameters, for example a parameter of correction of a bias in angular variation of the trajectory.

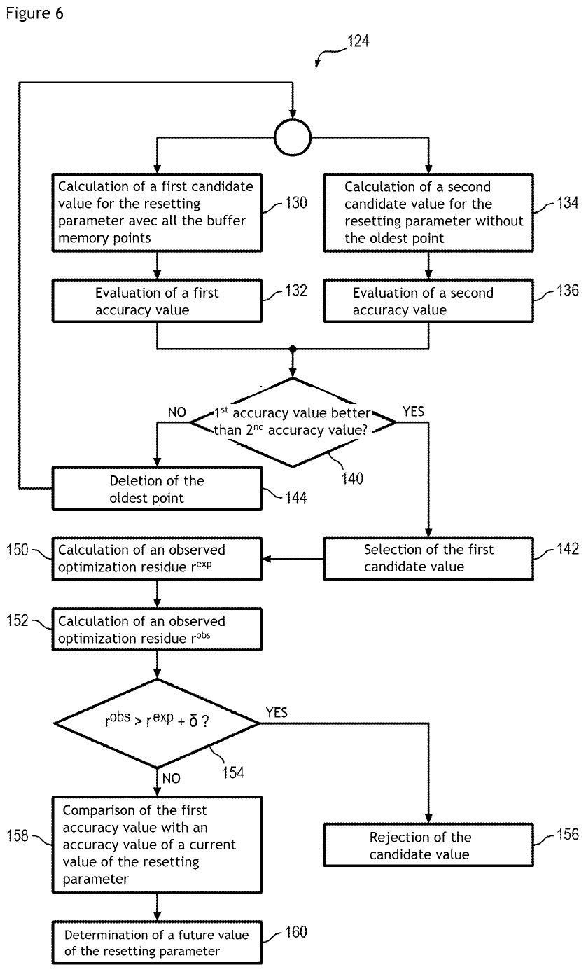

With reference to FIG. 6, this step 124 comprises a first sub-step 130 of calculating a first candidate value θ₁ for the heading resetting parameter θ with all the points, i.e. all the pairs of positions u(tₖ), v(tₖ), contained in the buffer memory 49. This first candidate value θ₁ is calculated by minimization of a cost function comparing the positions u(tₖ) evaluated at the N determination instants tₖ corresponding to the pairs of positions u(tₖ), v(tₖ) comprised in the buffer memory 49 with the estimated positions v(tₖ) for said N determination instants tₖ corrected by means of the heading resetting parameter θ and of the position resetting parameter Δ. This cost function is particularly representative of an average geometric deviation between the evaluated positions {uₖ}ₖ and the estimated positions {vₖ}ₖ after application to the evaluated positions {uₖ}ₖ of a geometric transformation comprising:
a rotation about an axis of the predetermined coordinate system, here the vertical axis, by an angle equal to the heading resetting parameter θ, and
a translation in a direction orthogonal to said axis of a vector equal to the position resetting parameter Δ.

Thus, the cost function is for example equal to

$$I ( θ , Δ ) = \frac{1}{2} {\sum }_{k = 1}^{N} {‖ {v}_{k} - R ( θ ) {u}_{k} - Δ ‖}^{2} ,$$

where:
{uₖ}ₖ is the set of positions evaluated at the determination instants;
{vₖ}ₖ is the set of positions estimated at the determination instants;
{tₖ}ₖ is the set of determination instants;
N is the number of pairs of positions u(tₖ), v(tₖ) comprised in the buffer memory 49;
θ is the heading resetting parameter;
R(θ) is the rotation matrix representative of the modification of the orientation by application of the heading resetting parameter; and
Δ is the position resetting parameter.

The first candidate value σ₁ is thus equal to

$$atan 2 ( {\sum }_{k = 1}^{N} ( {u}_{1} ( {t}_{k} ) - \overline{{u}_{1}} ) \times ( {v}_{2} ( {t}_{k} ) - \overline{{v}_{2}} ) - ( {u}_{2} ( {t}_{k} ) - \overline{{u}_{2}} ) \times ( {v}_{1} ( {t}_{k} ) - \overline{{v}_{1}} ) , {\sum }_{k = 1}^{N} ( {u}_{1} ( {t}_{k} ) - \overline{{u}_{1}} ) \times ( {v}_{1} ( {t}_{k} ) - \overline{{v}_{1}} ) + ( {u}_{2} ( {t}_{k} ) - \overline{{u}_{2}} ) \times ( {v}_{2} ( {t}_{k} ) - \overline{{v}_{2}} ) ) ,$$

where:
u₁(tₖ) is a first position coordinate, along a first axis of the predetermined fixed coordinate system, of the evaluated position of the dead reckoning navigation system 22 at a determination instant tₖ;
u̅₁̅ is an average of the first position coordinate of the evaluated position of the dead reckoning navigation system 22 over all the determination instants

$${\{ {t}_{k} \}}_{k = 1}^{N} ;$$

u₂(tₖ) is a second position coordinate, along a second axis of the predetermined fixed coordinate system, of the evaluated position of the dead reckoning navigation system 22 at a determination instant tₖ;
u̅₂̅ is an average of the second position coordinate of the evaluated position of the dead reckoning navigation system 22 over all the determination instants

$${\{ {t}_{k} \}}_{k = 1}^{N} ;$$

v₁(tₖ) is a first position coordinate, along a first axis of the arbitrary fixed coordinate system, of the estimated position of the dead reckoning navigation system 22 at a determination instant tₖ;
v̅₁̅ is an average of the first position coordinate of the estimated position of the dead reckoning navigation system 22 over all the determination instants

$${\{ {t}_{k} \}}_{k = 1}^{N} ;$$

v₂(tₖ) is a second position coordinate, along a second axis of the arbitrary fixed coordinate system, of the estimated position of the dead reckoning navigation system 22 at a determination instant tₖ;
v̅₂̅ is an average of the second position coordinate of the estimated position of the dead reckoning navigation system 22 over all the determination instants

$${\{ {t}_{k} \}}_{k = 1}^{N} ;$$

and
N is the number of pairs of positions u(tₖ), v(tₖ) comprised in the buffer memory 49.

As a variant (not represented), the cost function comprises a weighting of the different terms of the sum

$${\sum }_{k = 1}^{N} {‖ {v}_{k} - R ( θ ) {u}_{k} - Δ ‖}^{2} ,$$

for example based on the likelihood of said terms (typically the terms associated with higher variances would be assigned a lower weight) or on the geometric distance between the different terms (typically the terms geometrically close to each other would be assigned a lower weight). As a variant again, the geometric transformation is applied to the estimated positions {vₖ}ₖ and not to the evaluated positions {uₖ}ₖ: the terms of the sum are then written ∥uₖ−R(θ)vₖ−Δ∥². Still as a variant, the geometric transformation also comprises:
a smoothing of trajectory, parameterized by a parameter b of correction of a bias in angular variation of the trajectory: the terms of the sum are then written ∥vₖ−R(θ+b×tₖ)uₖ−Δ∥²;
and/or
a homothety, parameterized by a scale factor h: the terms of the sum are then written ∥vₖ−h×(R(θ)uₖ+Δ)∥².

This sub-step 130 is followed by a sub-step 132 of evaluating a first accuracy value σ_{θ1} associated with said first candidate value θ₁. This first accuracy value σ_{θ1} is for example a function of the uncertainties σᵥ, σᵤ on the estimated positions {vₖ}ₖ and the evaluated positions {uₖ}ₖ. It is typically constituted by the standard deviation of the first candidate value θ₁ and is given by the following formula:

$${σ}_{θ 1} = \sqrt{\frac{( 1 - \frac{1}{N} ) \times ( {σ}_{v}^{2} {\sum }_{k = 1}^{N} {‖ {u}_{k} - \overline{u} ‖}^{2} + {σ}_{u}^{2} {\sum }_{k = 1}^{N} {‖ {v}_{k} - \overline{v} ‖}^{2} )}{{‖ {\sum }_{k = 1}^{N} [ \begin{matrix}( {u}_{1} ( {t}_{k} ) - \overline{{u}_{1}} ) \times ( {v}_{1} ( {t}_{k} ) - \overline{{v}_{1}} ) + ( {u}_{2} ( {t}_{k} ) - \overline{{u}_{2}} ) \times ( {v}_{2} ( {t}_{k} ) - \overline{{v}_{2}} ) \\ ( {u}_{1} ( {t}_{k} ) - \overline{{u}_{1}} ) \times ( {v}_{2} ( {t}_{k} ) - \overline{{v}_{2}} ) - ( {u}_{2} ( {t}_{k} ) - \overline{{u}_{2}} ) \times ( {v}_{1} ( {t}_{k} ) - \overline{{v}_{1}} )\end{matrix} ] ‖}^{2}}} ,$$

where:
{uₖ}ₖ is the set of positions evaluated at the determination instants,
{vₖ}ₖ is the set of positions estimated at the determination instants,
{tₖ}ₖ is the set of determination instants,

$${σ}_{u}^{2}$$

is the variance of the random error affecting each coordinate of the position evaluated by the relative positioning system 24,

$${σ}_{v}^{2}$$

is the covariance of the random error affecting each coordinate of the position estimated by the dead reckoning navigation system 22,
u₁(tₖ) is a first position coordinate, along a first axis of the predetermined fixed coordinate system, of the evaluated position of the dead reckoning navigation system 22 at a determination instant tₖ,
u₂(tₖ) is a second position coordinate, along a second axis of the predetermined fixed coordinate system, of the evaluated position of the dead reckoning navigation system 22 at a determination instant tₖ,
v₁(tₖ) is a first position coordinate, along a first axis of the arbitrary fixed coordinate system, of the estimated position of the dead reckoning navigation system 22 at a determination instant tₖ,
v₂(tₖ) is a second position coordinate, along a second axis of the arbitrary fixed coordinate system, of the estimated position of the dead reckoning navigation system 22 at a determination instant tₖ,
u̅₁̅ is the average of the first position coordinate of the evaluated position of the dead reckoning navigation system 22 over all the determination instants

$${\{ {t}_{k} \}}_{k = 1}^{N} ,$$

u̅₂̅ is the average of the second position coordinate of the evaluated position of the dead reckoning navigation system 22 over all the determination instants

$${\{ {t}_{k} \}}_{k = 1}^{N} ,$$

v̅₁̅ is the average of the first position coordinate of the estimated position of the dead reckoning navigation system 22 over all the determination instants

$${\{ {t}_{k} \}}_{k = 1}^{N} ,$$

v̅₂̅ is the average of the second position coordinate of the estimated position of the dead reckoning navigation system 22 over all the determination instants

$${\{ {t}_{k} \}}_{k = 1}^{N} ,$$

and
N is the number of pairs of positions u(tₖ), v(tₖ) comprised in the buffer memory 49.

As a variant, the first accuracy value σ_{θ1} is a function of an average deviation observed between the set of evaluated positions {uₖ}ₖ and the set of associated estimated positions {vₖ}ₖ, corrected by means of the heading resetting parameter θ having the first candidate value θ₁. It is for example given by the following formula:

$${σ}_{θ1} = \sqrt{\frac{{\sum }_{k = 1}^{N} {‖ ( {v}_{k} - \overline{v} ) - R ( {θ}_{1} ) \times ( {u}_{k} - \overline{u} ) ‖}^{2}}{\frac{1}{2} {\sum }_{k = 1}^{N} {‖ ( {u}_{k} - \overline{u} ) ‖}^{2} + \frac{1}{2} {\sum }_{k = 1}^{N} {‖ ( {v}_{k} - \overline{v} ) ‖}^{2}}} ,$$

where:
N is the number of pairs of positions u(tₖ), v(tₖ) comprised in the buffer memory 49,
{uₖ}ₖ is the set of positions evaluated at the determination instants;
{vₖ}ₖ is the set of positions estimated at the determination instants;
ū is the average of the evaluated position of the dead reckoning navigation system 22 over the set of determination instants

$${\{ {t}_{k} \}}_{k = 1}^{N} ,$$

v̅ is the average of the estimated position of the dead reckoning navigation system 22 over the set of determination instants

$${\{ {t}_{k} \}}_{k = 1}^{N} ,$$

θ₁ is the heading resetting parameter assigned the first candidate value θ₁, and
R(θ₁) is the rotation matrix representative of the modification of the orientation by application of the heading resetting parameter.

As a variant, the first accuracy value σ_{θ1} is a combination of a function of the uncertainties σᵥ, σᵤ on the estimated positions {vₖ}ₖ and the evaluated positions {uₖ}ₖ and a function of an average deviation observed between the set of evaluated positions {uₖ}ₖ and the set of associated estimated positions {vₖ}ₖ, corrected by means of the heading resetting parameter θ having the first candidate value θ₁.

In parallel with sub-steps 130, 132, the deduction step 124 also comprises a sub-step 134 of calculating a second candidate value θ₂ for the heading resetting parameter θ without the oldest point contained in the buffer memory 49, i.e. with all the pairs of positions u(tₖ), v(tₖ) contained in the buffer memory 49 except the pair of positions u(t₁), v(t₁) associated with the oldest determination instant t₁. This second candidate value θ₂ is calculated by minimizing a cost function comparing the positions u(tₖ) evaluated at the N−1 determination instants tₖ corresponding to the most recent pairs of positions u(tₖ), v(tₖ) comprised in the buffer memory 49 with the estimated positions v(tₖ) for said N−1 determination instants tₖ corrected by means of the heading resetting parameter θ and the position resetting parameter Δ. This cost function is particularly representative of an average geometric deviation between the evaluated positions {uₖ}ₖ and the estimated positions {vₖ}ₖ after application to the evaluated positions {uₖ}ₖ of a geometric transformation comprising:
a rotation about an axis of the predetermined coordinate system, here the vertical axis, by an angle equal to the heading resetting parameter θ, and
a translation in a direction orthogonal to said axis of a vector equal to the position resetting parameter Δ.

Thus, the cost function is for example equal to

$$I ( θ , Δ ) = \frac{1}{2} {\sum }_{k = 2}^{N} {‖ {v}_{k} - R ( θ ) {u}_{k} - Δ ‖}^{2} ,$$

where:
{uₖ}ₖ is the set of positions evaluated at the determination instants;
{vₖ}ₖ is the set of positions estimated at the determination instants;
{tₖ}ₖ is the set of determination instants;
N is the number of pairs of positions u(tₖ), v(tₖ) comprised in the buffer memory 49;
θ is the heading resetting parameter;
R(θ) is the rotation matrix representative of the modification of the orientation by application of the heading resetting parameter; and
Δ is the position resetting parameter.

The second candidate value θ₂ is thus equal to

$$atan 2 ( {\sum }_{k = 2}^{N} ( {u}_{1} ( {t}_{k} ) - \overline{{u}_{1}} ) \times ( {v}_{2} ( {t}_{k} ) - \overline{{v}_{2}} ) - ( {u}_{2} ( {t}_{k} ) - \overline{{u}_{2}} ) \times ( {v}_{1} ( {t}_{k} ) - \overline{{v}_{1}} ) , {\sum }_{k = 2}^{N} ( {u}_{1} ( {t}_{k} ) - \overline{{u}_{1}} ) \times ( {v}_{1} ( {t}_{k} ) - \overline{{v}_{1}} ) + ( {u}_{2} ( {t}_{k} ) - \overline{{u}_{2}} ) \times ( {v}_{2} ( {t}_{k} ) - \overline{{v}_{2}} ) ) ,$$

where:
u₁(tₖ) is a first position coordinate, along a first axis of the predetermined fixed coordinate system, of the evaluated position of the dead reckoning navigation system 22 at a determination instant tₖ;
u̅₁̅ is an average of the first position coordinate of the evaluated position of the dead reckoning navigation system 22 over all the determination instants except the oldest one

$${\{ {t}_{k} \}}_{k = 2}^{N} ;$$

u₂(tₖ) is a second position coordinate, along a second axis of the predetermined fixed coordinate system, of the evaluated position of the dead reckoning navigation system 22 at a determination instant tₖ;
u̅₂̅ is an average of the second position coordinate of the evaluated position of the dead reckoning navigation system 22 over all the determination instants except the oldest one

$${\{ {t}_{k} \}}_{k = 2}^{N} ;$$

v₁(tₖ) is a first position coordinate, along a first axis of the arbitrary fixed coordinate system, of the estimated position of the dead reckoning navigation system 22 at a determination instant tₖ;
v̅₁̅ is an average of the first position coordinate of the estimated position of the dead reckoning navigation system 22 over all the determination instants except the oldest one

$${\{ {t}_{k} \}}_{k = 2}^{N} ;$$

v₂(t) is a second position coordinate, along a second axis of the arbitrary fixed coordinate system, of the estimated position of the dead reckoning navigation system 22 at a determination instant tₖ;
v̅₂̅ is an average of the second position coordinate of the estimated position of the dead reckoning navigation system 22 over all the determination instants except the oldest one

$${\{ {t}_{k} \}}_{k = 2}^{N} ;$$

and
N is the number of pairs of positions u(tₖ), v(tₖ) comprised in the buffer memory 49.

As a variant (not represented), the cost function comprises a weighting of the different terms of the sum

$${\sum }_{k = 2}^{N} {‖ {v}_{k} - R ( θ ) {u}_{k} - Δ ‖}^{2} ,$$

for example based on the likelihood of said terms (typically the terms associated with higher variances would be assigned a lower weight) or on the geometric distance between the different terms (typically the terms geometrically close to each other would be assigned a lower weight). As a variant again, the geometric transformation is applied to the estimated positions {vₖ}ₖ and not to the evaluated positions {uₖ}ₖ: the terms of the sum are then written ∥uₖ−R(θ)vₖ−Δ∥². As a variant again, the geometric transformation also comprises:
a smoothing of trajectory, parameterized by a parameter b of correction of a bias in angular variation of the trajectory: the terms of the sum are then written ∥vₖ−R(θ+b×tₖ)uₖ−Δ∥²;
and/or
a homothety, parameterized by a scale factor h: the terms of the sum are then written ∥vₖ−h×(R(θ)uₖ+Δ)∥².

This sub-step 134 is followed by a sub-step 136 of evaluating a second accuracy value σ_{θ2} associated with said second candidate value θ₂. This second accuracy value σ_{θ2} is for example a function of the uncertainties σᵥ, σᵤ on the estimated positions {vₖ}ₖ the evaluated positions {uₖ}ₖ. It is typically constituted by the standard deviation of the second candidate value θ₂ and is given by the following formula:

$${σ}_{θ 2} = \sqrt{\frac{( 1 - \frac{1}{N} ) \times ( {σ}_{v}^{2} {\sum }_{k = 2}^{N} {‖ {u}_{k} - \overline{u} ‖}^{2} + {σ}_{u}^{2} {\sum }_{k = 2}^{N} {‖ {v}_{k} - \overline{u} ‖}^{2} )}{{‖ {\sum }_{k = 2}^{N} [ \begin{matrix}( {u}_{1} ( {t}_{k} ) - \overline{{u}_{1}} ) \times {v}_{1} ( {t}_{k} ) - \overline{{v}_{1}} ) + ( {u}_{2} ( {t}_{k} ) - \overline{{u}_{2}} ) \times {v}_{2} ( {t}_{k} ) - \overline{{v}_{2}} ) \\ ( {u}_{1} ( {t}_{k} ) - \overline{{u}_{1}} ) \times {v}_{2} ( {t}_{k} ) - \overline{{v}_{2}} ) + ( {u}_{2} ( {t}_{k} ) - \overline{{u}_{2}} ) \times {v}_{1} ( {t}_{k} ) - \overline{{v}_{1}} )\end{matrix} ] ‖}^{2}}} ,$$

where:
{uₖ}ₖ is the set of positions evaluated at the determination instants,
{vₖ}ₖ is the set of positions estimated at the determination instants,
{tₖ}ₖ is the set of determination instants,

$${σ}_{u}^{2}$$

is the covariance of the random error affecting each coordinate of the position evaluated by the relative positioning system 24,

$${σ}_{v}^{2}$$

is the covariance of the random error affecting each coordinate of the position estimated by the dead reckoning navigation system 22,
u₁(tₖ) is a first position coordinate, along a first axis of the predetermined fixed coordinate system, of the evaluated position of the dead reckoning navigation system 22 at a determination instant tₖ,
u₂(tₖ) is a second position coordinate, along a second axis of the predetermined fixed coordinate system, of the evaluated position of the dead reckoning navigation system 22 at a determination instant tₖ,
v₁(tₖ) is a first position coordinate, along a first axis of the arbitrary fixed coordinate system, of the estimated position of the dead reckoning navigation system 22 at a determination instant tₖ,
v₂(tₖ) is a second position coordinate, along a second axis of the arbitrary fixed coordinate system, of the estimated position of the dead reckoning navigation system 22 at a determination instant tₖ,
u̅₁̅₂̅ is the average of the first position coordinate of the evaluated position of the dead reckoning navigation system 22 over all the determination instants except the oldest one

$${\{ {t}_{k} \}}_{k = 2}^{N} ,$$

u̅₂̅ is the average of the second position coordinate of the evaluated position of the dead reckoning navigation system 22 over all the determination instants except the oldest one

$${\{ {t}_{k} \}}_{k = 2}^{N} ,$$

v̅₁̅ is the average of the first position coordinate of the estimated position of the dead reckoning navigation system 22 over all the determination instants except the oldest one

$${\{ {t}_{k} \}}_{k = 2}^{N} ,$$

v̅₂̅ is the average of the second position coordinate of the estimated position of the dead reckoning navigation system 22 over all the determination instants except the oldest one

$${\{ {t}_{k} \}}_{k = 2}^{N} ,$$

and
N is the number of pairs of positions u(tₖ), v(tₖ) comprised in the buffer memory 49.

As a variant, the second accuracy value σ_{θ2} is a function of an average deviation observed between the set of evaluated positions {uₖ}ₖ and the set of associated estimated positions {vₖ}ₖ, corrected by means of the heading resetting parameter θ having the second candidate value θ₂. It is for example given by the following formula:

$${σ}_{θ 2} = \sqrt{\frac{{\sum }_{k = 2}^{N} {‖ ( {v}_{k} - \overline{v} ) - R ( {θ}_{2} ) \times ( {u}_{k} - \overline{u} ) ‖}^{2}}{\frac{1}{2} {\sum }_{k = 2}^{N} {‖ {u}_{k} - \overline{u} ‖}^{2} + \frac{1}{2} {\sum }_{k = 2}^{N} {‖ {v}_{k} - \overline{v} ‖}^{2}}} ,$$

where:
N is the number of pairs of positions u(tₖ), v(tₖ) comprised in the buffer memory 49,
{uₖ}ₖ is the set of positions evaluated at the determination instants;
{vₖ}ₖ is the set of positions estimated at the determination instants;
ū is the average of the evaluated position of the dead reckoning navigation system 22 over all the determination instants except the oldest one

$${\{ {t}_{k} \}}_{k = 2}^{N} ,$$

v̅ is the average of the estimated position of the dead reckoning navigation system 22 over all the determination instants except the oldest one

$${\{ {t}_{k} \}}_{k = 2}^{N} ,$$

θ₂ is the heading resetting parameter assigned the second candidate value θ₂, and
R(θ₂) is the rotation matrix representative of the modification of the orientation by application of the heading resetting parameter.

As a variant, the first accuracy value σ_{θ2} is a combination of a function of the uncertainties σᵥ, σᵤ on the estimated positions {vₖ}ₖ and the evaluated positions {uₖ}ₖ and a function of an average deviation observed between the set of evaluated positions {uₖ}ₖ and the set of associated estimated positions {vₖ}ₖ, corrected by means of the heading resetting parameter θ having the first candidate value θ₂.

Sub-steps 132 and 136 are followed by a sub-step 140 of comparing the first accuracy value σ_{θ1} with the second accuracy value σ_{θ2}.

If the first accuracy value σ_{θ1} reflects a better accuracy than the second value σ_{θ2}, i.e. here if σ_{θ1}<σ_{θ2}, then step 140 is followed by a step 142 of selecting the first candidate value θ₁ as the selected candidate value.

If, on the other hand, the accuracy value reflecting the best accuracy is constituted by the second accuracy value σ_{θ2}, i.e. here if σ_{θ1}>σ_{θ2}, then step 140 is followed by a step 144 of deleting the oldest point of the buffer memory 49, i.e. the pair of positions u(t₁), v(t₁) associated with the oldest determination instant t₁. The remaining determination instants

$${\{ {t}_{k} \}}_{k = 2}^{N}$$

are then renumbered as

$${\{ {t}_{k} \}}_{k = 1}^{N - 1}$$

and steps 130 to 140 are repeated.

This makes it possible to maximize the accuracy of the resetting parameter θ.

Sub-step 142 is optionally followed by a set of sub-steps 150 to 154 aimed at validating the new resetting parameter θ from a residue calculation.

Sub-step 142 is then followed by a sub-step 150 of calculating an expected resetting residue r^{exp}. This resetting residue is intended to reflect the expected average deviation between the set of evaluated positions {uₖ}ₖ and the set of associated estimated positions {vₖ}ₖ, corrected by means of the heading resetting parameter θ. It is given by the following formula:

$${r}^{exp} = 2 ( 1 - \frac{1}{N} ) ( {σ}_{u}^{2} + {σ}_{v}^{2} ) + \frac{{σ}_{θ}^{2}}{N} ‖ {\sum }_{k = 1}^{N} [ \begin{matrix}( {u}_{1} ( {t}_{k} ) - \overline{{u}_{1}} ) \times ( {v}_{1} ( {t}_{k} ) - \overline{{v}_{1}} ) + ( {u}_{2} ( {t}_{k} ) - \overline{{u}_{2}} ) \times ( {v}_{2} ( {t}_{k} ) - \overline{{v}_{2}} ) \\ ( {u}_{1} ( {t}_{k} ) - \overline{{u}_{1}} ) \times ( {v}_{2} ( {t}_{k} ) - \overline{{v}_{2}} ) + ( {u}_{2} ( {t}_{k} ) - \overline{{u}_{2}} ) \times ( {v}_{1} ( {t}_{k} ) - \overline{{v}_{1}} )\end{matrix} ] ‖ ,$$

where:
N is the number of pairs of positions u(tₖ), v(tₖ) comprised in the buffer memory 49,

$${σ}_{u}^{2}$$

is the covariance of the random error affecting each coordinate of the position evaluated by the relative positioning system 24,

$${σ}_{v}^{2}$$

is the covariance of the random error affecting each coordinate of the position estimated by the dead reckoning navigation system 22,

$${σ}_{θ}^{2}$$

is the covariance of the resetting parameter θ, equal to the square of the standard deviation σ_{θ1}, discussed above, of the selected candidate value θ₁,
u₁(tₖ) is a first position coordinate, along a first axis of the predetermined fixed coordinate system, of the evaluated position of the dead reckoning navigation system 22 at a determination instant tₖ,
u₂(tₖ) is a second position coordinate, along a second axis of the predetermined fixed coordinate system, of the evaluated position of the dead reckoning navigation system 22 at a determination instant tₖ,
v₁(tₖ) is a first position coordinate, along a first axis of the arbitrary fixed coordinate system, of the estimated position of the dead reckoning navigation system 22 at a determination instant tₖ,
v₂(tₖ) is a second position coordinate, along a second axis of the arbitrary fixed coordinate system, of the estimated position of the dead reckoning navigation system 22 at a determination instant tₖ,
u̅₁̅ is the average of the first position coordinate of the evaluated position of the dead reckoning navigation system 22 over all the determination instants

$${\{ {t}_{k} \}}_{k = 1}^{N} ,$$

u̅₂̅ is the average of the second position coordinate of the evaluated position of the dead reckoning navigation system 22 over all the determination instants

$${\{ {t}_{k} \}}_{k = 1}^{N} ,$$

v̅₁̅ is the average of the first position coordinate of the estimated position of the dead reckoning navigation system 22 over all the determination instants

$${\{ {t}_{k} \}}_{k = 1}^{N} ,$$

and
v̅₂̅ is the average of the second position coordinate of the estimated position of the dead reckoning navigation system 22 over all the determination instants

$${\{ {t}_{k} \}}_{k = 1}^{N} .$$

Sub-step 150 is followed by a sub-step 152 of calculating an observed resetting residue r^{obs}. This resetting residue is intended to reflect the average deviation observed between the set of evaluated positions {uₖ}ₖ and the set of associated estimated positions {vₖ}ₖ, corrected by means of the heading resetting parameter θ assigned the selected candidate value θ₁. It is given by the following formula:

$${r}^{obs} = \frac{1}{N} {\sum }_{k} {‖ ( {v}_{k} - \overline{v} ) - R ( θ ) \times ( {u}_{k} - \overline{u} ) ‖}^{2} ,$$

where:
N is the number of pairs of positions u(tₖ), v(tₖ) comprised in the buffer memory 49,
{uₖ}ₖ is the set of positions evaluated at the determination instants;
{vₖ}ₖ is the set of positions estimated at the determination instants;
ū is the average of the evaluated position of the dead reckoning navigation system 22 over the set of determination instants

$${\{ {t}_{k} \}}_{k = 1}^{N} ,$$

v̅ is the average of the estimated position of the dead reckoning navigation system 22 over the set of determination instants

$${\{ {t}_{k} \}}_{k = 1}^{N} ,$$

θ is the heading resetting parameter, and
R(θ) is the rotation matrix representative of the modification of the orientation by application of the heading resetting parameter.

Sub-step 152 is followed by a sub-step 154 of comparing the observed resetting residue r^{obs} with the expected resetting residue r^{exp}, increased by a predetermined threshold 6.

If the observed resetting residue r^{obs} is strictly greater than the sum of the expected resetting residue r^{exp} with the threshold 6, i.e. if the inequality r^{obs}>r^{exp}+8 is met, then sub-step 154 is followed by a sub-step 156 of rejecting the selected candidate value. The resetting parameter θ then retains its previous value.

If the observed resetting residue r^{obs} is less than or equal to the sum of the expected resetting residue r^{exp} with the threshold 6, i.e. if the inequality r^{obs}<r^{exp}+δ is met, then sub-step 154 is followed by a sub-step 158 of comparing the accuracy value σ_{θn} associated with the selected candidate value with an accuracy value σ_{θo} associated with a current value of the resetting parameter θ. It will be noted that, given the candidate value selection algorithm, the accuracy value σ_{θn} associated with the selected candidate value is equal to the first accuracy value σ_{θ1} described above.

More specifically, sub-step 158 comprises the comparison of the accuracy value σ_{θn} associated with the selected candidate value with the accuracy value σ_{θo} associated with the current value of the resetting parameter θ increased by a time drift value proportional to the time elapsed between the determination of the selected candidate value and the determination of the current value of the heading resetting parameter θ. This time drift value is typically equal to (tₙ−tₒ)×b, where:
tₙ is an instant representative of the determination instants {tₖ}ₖ taken into consideration for the determination of the selected candidate value,
tₒ is an instant representative of the determination instants {tₖ}ₖ taken into consideration for the determination of the current value of the heading resetting parameter θ, and
b is a predefined constant representing a typical bias value of the gyrometer 40.

Each of the instants tₒ, tₙ is for example constituted by the average of the determination instants {tₖ}ₖ taken into consideration for the determination of the selected candidate value, respectively for the determination of the current value of the heading resetting parameter θ. As a variant, each of the instants to, to is for example constituted by the most recent determination instant tₖ taken into consideration for the determination of the selected candidate value, respectively for the determination of the current value of the heading resetting parameter θ.

In the case where the sub-step 158 is implemented for the first time since the dead reckoning navigation system 22 was started, the accuracy value σ_{θo} associated with the current value of the resetting parameter θ is preferably infinite.

Sub-step 158 is followed by a sub-step 160 of determining a future value of the resetting parameter θ as a function of the result of the comparison 158. This future value is typically a function of the candidate value and the current value.

For example, if the accuracy value σ_{θn} associated with the selected candidate value is greater than or equal to the accuracy value σ_{θo} associated with the current value increased by the time drift value, i.e. if the following inequality is met: σ_{θn}≥σ_{θo}+(tₙ−tₒ)×b, then the future value is equal to the current value, and if on the other hand the accuracy value σ_{θn} associated with the selected candidate value is strictly smaller than the accuracy value σ_{θo} associated with the current value increased by the time drift value, i.e. if the following inequality is met: σ_{θn}<σ_{θn}+(tₙ−tₒ)×b, then the future value is equal to the selected candidate value.

As a variant, the future value is equal to a combination of the selected candidate value and the current value as a function of the ratio between the accuracy value σ_{θn} associated with the selected candidate value and the accuracy value σ_{θo} associated with the current value increased by the time drift value, typically by application of a Kalman filter or Bayesian fusion. For example, the future value is equal to

$${θ}_{n} \times \frac{{( {σ}_{θ o} + ( {t}_{n} - {t}_{o} ) \times b )}^{2}}{{σ}_{θ n}^{2} + {( {σ}_{θ o} + ( {t}_{n} - {t}_{o} ) \times b )}^{2}} + {θ}_{o} \times \frac{{σ}_{θ n}^{2}}{{σ}_{θ n}^{2} + {( {σ}_{θ o} + ( {t}_{n} - {t}_{o} ) \times b )}^{2}} ,$$

where:
θₙ is the selected candidate value,
σ_{θo} is the accuracy value associated with said selected candidate value,
θ₀ is the current value of the heading resetting parameter θ, and
σ_{θo} is the accuracy value associated with said current value.

This sub-step 160 concludes step 124 of deducing the heading resetting parameter θ.

Returning to FIG. 5, step 124 is followed by a step 126 of adjusting the evaluated heading. During this step 126, the dead reckoning navigation system 22 adjusts the estimated heading by applying the heading resetting parameter θ: \hat{ψ}(t)=ψ(t)−θ.

This step 126 concludes the heading resetting step 107.

Returning to FIG. 4, the position resetting 106 and heading resetting 107 steps are followed by a step 109 of calculating a position of the pedestrian 12 by the dead reckoning navigation system 22. During this step 109, the dead reckoning navigation system 22 applies the heading and position resetting parameters to determine the position of the pedestrian 12 in the predetermined coordinate system. This position is determined by the following formula: \hat{x}(t)=R(θ)^{T}(v(t)−Δ), where:
\hat{x}(t) is a position of the pedestrian 12 in the predetermined coordinate system calculated by the dead reckoning navigation system 22,
v(t) is the position of the pedestrian 12 in the arbitrary coordinate system estimated by the dead reckoning navigation system 22,
θ is the heading resetting parameter,
R(θ)^{T} is the rotation matrix representative of the modification of the orientation by application of the inverse of the heading resetting parameter, and
Δ is the position resetting parameter.

The method 100 then loops back to step 109 so as to allow a continuous update of the calculated position x̅(t).

In parallel, the method 100 returns to step 104, so as to allow a continuous update of the heading θ and position Δ resetting parameters each time the pedestrian 12 passes near the beacons 54.

Thanks to the exemplary embodiment described above, it is thus possible to accurately track, in a simple and economical manner, the movement of people inside a building. This objective is indeed achieved thanks to the particularly lightweight infrastructure 18 that only needs to be deployed and to the particularly simple location boxes 16 that just need to equip the people to be tracked. The motion sensors 30 equipping these boxes 16 do not need to be very accurate since the dead reckoning navigation system can be regularly reset each time a person passes near the infrastructure 18.

Particularly, the use of UWB technology for the relative positioning system 24 is particularly advantageous because it allows, thanks to the low level of error of the UWB location, obtaining a very accurate resetting for a small range of movement. It therefore allows very significantly reducing the infrastructure requirements. It is also completely transparent for the pedestrian 12, who does not have to perform any special task to ensure the resetting of his location box 16.

1. An attitude resetting method for resetting an attitude provided by a dead reckoning navigation system, the attitude resetting method comprising the following steps:
estimating, by the dead reckoning navigation system, for each of a plurality of determination instants comprised in a movement interval during which the dead reckoning navigation system moves along a movement trajectory, an estimated position of the dead reckoning navigation system in an arbitrary fixed coordinate system at said determination instant,
obtaining, for each determination instant, an evaluated position of the dead reckoning navigation system at said determination instant in a predetermined fixed coordinate system, said evaluated position having been evaluated by a relative positioning system, and
deducing at least one attitude resetting parameter by minimizing a cost function comparing the evaluated positions to the estimated positions corrected by means of the or each resetting parameter.

2. The attitude resetting method according to claim 1, wherein the dead reckoning navigation system is worn by a pedestrian.

3. The attitude resetting method according to claim 1, wherein the dead reckoning navigation system includes a motion sensor for measuring a measured motion of the dead reckoning navigation system and a processing unit for deducing from the measured motion an attitude and a position of the dead reckoning navigation system.

4. The attitude resetting method according to claim 1, wherein the relative positioning system is selected from: a multi-angulation system, a multi-lateration system, a map matching system and a visual positioning system.

5. The attitude resetting method according to claim 1, wherein the arbitrary fixed coordinate system and the predetermined fixed coordinate system share a common axis, an attitude resetting parameter being constituted by a parameter, preferably an angle, of modification of orientation by rotation about said common axis.

6. The attitude resetting method according to claim 1, wherein the cost function is representative of an average geometric deviation between the evaluated positions and the estimated positions after application to the evaluated or estimated positions of a geometric transformation comprising a rotation and, preferably, a translation.

7. The attitude resetting method according to claim 1, wherein the step of deducing the resetting parameter comprises calculating a candidate value for the resetting parameter, evaluating an accuracy value of said candidate value, comparing said accuracy value with a previous accuracy value associated with a previous resetting parameter, and determining the resetting parameter as a function of the result of the step of comparing the accuracy value with a previous accuracy value, the resetting parameter depending on the candidate value and on the previous resetting parameter.

8. The attitude resetting method according to claim 7, wherein the accuracy value is a function of uncertainties on the estimated positions and the evaluated positions and/or of an average geometric deviation between the evaluated positions and the estimated positions after application of the candidate value of the resetting parameter.

9. The attitude resetting method according to claim 1, wherein the step of deducing the resetting parameter comprises the following sub-steps:
a) calculating a first candidate value for the resetting parameter by minimizing a cost function comparing the positions evaluated for N determination instants with the positions estimated for said N determination instants corrected by means of the resetting parameter,
b) calculating a first accuracy value associated with said first candidate value,
c) calculating a second candidate value for the resetting parameter by minimizing a cost function comparing the positions evaluated for N−1 determination instants, corresponding to said N determination instants minus an oldest determination instant, with the estimated positions for said N−1 determination instants corrected by means of the or each resetting parameter,
d) calculating a second accuracy value associated with said second candidate value,
e) comparing the first and second accuracy values, and
f) selecting the first candidate value when the first accuracy value reflects the best accuracy.

10. The attitude resetting method according to claim 9, wherein, when the accuracy value reflecting the best accuracy is constituted by the second accuracy value, the step of deducing the resetting parameter comprises the following additional sub-steps:
deleting the evaluated position and the estimated position for the oldest determination instant, and
repeating the sub-steps a) to e) with a number N reduced by 1.

11. A method for locating an object in a predefined space, the object carrying a dead reckoning navigation system, the method comprising the following steps:
starting the dead reckoning navigation system,
resetting an attitude of the dead reckoning navigation system using a relative positioning system comprising an infrastructure installed at a point of access to the predefined space, so as to obtain an attitude resetting parameter, said attitude resetting implementing the attitude resetting method according to claim 1,
resetting a position of the dead reckoning navigation system using a relative positioning system comprising an infrastructure installed at said point of access to the predefined space, so as to obtain a position resetting parameter, and
calculating, by the dead reckoning navigation system, by means of the attitude resetting parameter and the position resetting parameter, a calculated position of the dead reckoning navigation system in the predetermined coordinate system.

12. The location method according to claim 11, wherein the infrastructure is carried on board a vehicle itself equipped with a location and orientation system making it possible to calculate a position of the infrastructure in the predetermined coordinate system.

13. A dead reckoning navigation system including a motion sensor for measuring a motion of the dead reckoning navigation system and a processing unit for deducing from the measured motion an attitude and a position of the dead reckoning navigation system in a fixed coordinate system, the processing unit being configured to implement the attitude resetting method according to claim 1 to reset said attitude.

14. (canceled)

15. A storage means readable by computer equipment on which a computer program product comprising code instructions for executing the attitude resetting method according to claim 1.
